(19) United States
(12) Patent Application Publication
(10) Pub. No.: US 2011/0246307 A1
(43) Pub. Date: Oct. 6, 2011

(54) Mass-Based Approach for Serving Impressions in Guaranteed Delivery Advertising

(76) Inventors: Martin Zinkevich, Santa Clara, CA (US); Jayavel Shanmugasundaram, Santa Clara, CA (US); Sergei Vassilvitskii, New York, NY (US); Erik Vee, San Mateo, CA (US)

(21) Appl. No.: 12/751,693

(22) Filed: Mar. 31, 2010

(51) Int. Cl. G06Q 30/00

(52) U.S. Cl. 705/14.61

(57) ABSTRACT

A computer-implemented Internet advertising method for serving impression opportunities in a system for delivery of display advertising. The likelihood that a booked contract could be served by a future forecasted user visit is calculated as a probability mass, and associated with the booked contract. The relative sizes of the probability masses of a plurality of eligible contracts is used as a selector in conjunction with a selected pseudo-random number. In exemplary embodiments, a server is configured for receiving an event predicate as a result of a user visit to a web site. Based on the received event predicate, a set of eligible contracts is assembled. Each eligible contract is assigned to exactly one interval selected from a range, the size of the interval corresponding to the probability mass of the eligible contract. The generated pseudo-random number is used for selecting an interval, which operation selects an eligible advertisement for display.

### FIELD OF THE INVENTION

The present invention relates generally to advertising, more specifically to the optimization of an advertisement delivery plan for allocating advertisements to a contract in a network-based environment.

### BACKGROUND OF THE INVENTION

Since the widespread acceptance of the Internet, advertising as a source of revenue has proven to be both effective and lucrative. Advertising on the Internet provides the possibility of allowing advertisers to cost-effectively reach highly specific target audiences as opposed to traditional print and “hard copy” advertising media that reach only broadly definable target audiences (e.g. radio listeners in the greater Memphis area).

The very nature of the Internet facilitates a two-way flow of information between users and advertisers and allows these transactions to be conducted in real time or near-to-real time. For example, a user may request an ad and may intentionally, or inherently, transmit various pieces of data describing himself or herself. Additionally, an advertising management system may be able to intelligently determine which ads to place on a given website requesting advertisement content, thus increasing the revenue for the parties involved and increasing user satisfaction by eliminating “nuisance” ads.

Current systems, however, fail to fully exploit the interactive aspects of the Internet in the advertising realm. Most current advertising systems need to coordinate a number of components such as components for forecasting web traffic, for procuring ad placements based on target demographics, and for delivering display ads. Within this architecture, each component relies on the cooperative and reliable performance of the others. Unfortunately, current advertising systems are decoupled. A decoupled system results in a number of inconsistencies with respect to contracts for the promised placement and delivery of advertisements. Even just a slight overestimation of future web traffic may jeopardize an advertising system's ability to deliver the advertisements promised. Likewise, an underestimation of future web traffic hurts advertisers and publishers alike because of lost opportunities for ad placements.

Current systems create a strict and artificial separation between display inventory of available advertisement placements that is sold many months in advance in a guaranteed fashion (e.g. guaranteed delivery), and display inventory that is sold using a real-time auction in a market or through other means (e.g. non-guaranteed delivery). For instance, the Yahoo!® advertising system may serve guaranteed contracts their desired quota before serving non-guaranteed contracts, creating a possibly unnecessary and also possibly inefficient bias toward guaranteed contracts. While acceptable in the past, the shift in the advertising industry demands an efficient mix of guaranteed and non-guaranteed contracts.

Another flaw with the decoupled advertising system is the failure to take advantage of the stores of information available when pricing contracts and allocating advertisements to advertisement placements. For example, the current pricing systems use advertising information and contract information at a granularity and specificity that is coarse and untargeted. The failure to mine and use information regarding how advertisement placements may be allocated at a more granular level creates a gap between the price paid for an advertisement placement and the actual value that a contract derives from the advertisements placed.

This failure leads to the inability of legacy systems to provide more refined and targeted advertisements. To the contrary, increased refinement in targeting allows advertisers to reach a more relevant customer base. The frustration of advertisers moving from broad targeting parameters (e.g. “1 million Yahoo! Finance users) to more fine-grained parameters (e.g. “100,000 Yahoo! Finance users from September 2008-December 2008 who are California males between the ages of 20-35 working in the healthcare industry”) is evident. Unfortunately, the increased refinement and targeting is not computationally pragmatic within the context of legacy system designs.

Accordingly, there exists a need for a more unified marketplace for the optimization of an advertisement plan and allocation of advertisements to a contract in a network-based environment.

### SUMMARY OF THE INVENTION

A computer-implemented Internet advertising method and advertising server network for serving impression opportunities in a system for delivery of display advertising. A probability mass (a numeric value) models the likelihood that a booked contract could be served by a future forecasted user visit. The probability mass is calculated using a collection of booked contracts, and a sample of forecasted user visits; a resulting probability mass is associated with each of the booked contracts. The relative sizes of the probability masses of a plurality of eligible contracts is used a selector in conjunction with a generated pseudo random number. In exemplary embodiments, a server is configured for receiving an event predicate as a result of a user visit to a web site. Based on the received event predicate, a set of eligible contracts is assembled. The eligible contracts are assigned to exactly one interval selected from a range, the size of the interval corresponding to the probability mass of the eligible contract. A generated pseudo-random number is used for selecting a single interval corresponding to an eligible contract, and the advertisement of the selected eligible contract is served. Thus, eligible contracts are served to user visits probabilistically.

### BRIEF DESCRIPTION OF THE DRAWINGS

The novel features of the invention are set forth in the appended claims. However, for purpose of explanation, several embodiments of the invention are set forth in the following figures.

FIG. 1 depicts an advertising server network environment including modules for implementing a mass-based approach for serving impressions in guaranteed delivery advertising, in which some embodiments operate.

FIG. 2 depicts an index with target predicates in the form of an inverted index, according to one embodiment.

FIG. 3 depicts an allocation of impressions to contracts in the form of a bipartite eligibility graph, according to one embodiment.

FIG. 4 is a flowchart of a method for implementing a mass-based approach for serving impressions in guaranteed delivery advertising, according to one embodiment.

FIG. 5 is a flowchart of a method for assigning a mass to a contract by simulating a series of supply events, according to one embodiment.

FIG. 6 is a depiction of a data structure for assigning a mass to a contract after simulating a series of supply events, according to one embodiment.

FIG. 7A is a depiction of a technique for assigning eligible contracts to non-overlapping intervals within a contiguous range, according to one embodiment.

FIG. 7B is a depiction of a technique for assigning eligible contracts to non-overlapping intervals within a non-contiguous range, according to one embodiment.

FIG. 8 is a flowchart of a method for implementing operations within a mass-based approach for serving impressions in guaranteed delivery advertising, according to one embodiment.

FIG. 9 is a system diagram of a system implementing operations within a mass-based approach for serving impressions in guaranteed delivery advertising, according to one embodiment.

FIG. 10 depicts a block diagram of a system for delivery of display advertising, in accordance with one embodiment of the invention.

FIG. 11 depicts a block diagram of a system to perform certain functions of an advertising server network, in accordance with one embodiment of the invention.

FIG. 12 is a diagrammatic representation of a network including nodes for client computer systems, nodes for server computer systems and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### Introduction to Guaranteed Delivery Display Advertising

Guaranteed delivery display advertising is a form of online advertising whereby advertisers can buy a fixed number of targeted user visits in advance, and publishers guarantee these user visits. In case the guarantee is not met, the publisher incurs some penalty (monetary or otherwise), so it is in the best interest of the publisher to try and meet the guarantees. For example, a sports shoe manufacturer (an advertiser) can buy one hundred million user visits for Males in California who visit Yahoo! Sports between 1 Jun. 2010 and 15 Jun. 2010, and Yahoo! (as a publisher) will guarantee these user visits even though the duration of interest occurs several months later than the current date. The guaranteed delivery model of online display advertising is prevalent among the major advertising networks such as Yahoo!, AOL, and MSN, and represents a multi-billion dollar industry.

### Overview of Networked Systems for Online Advertising

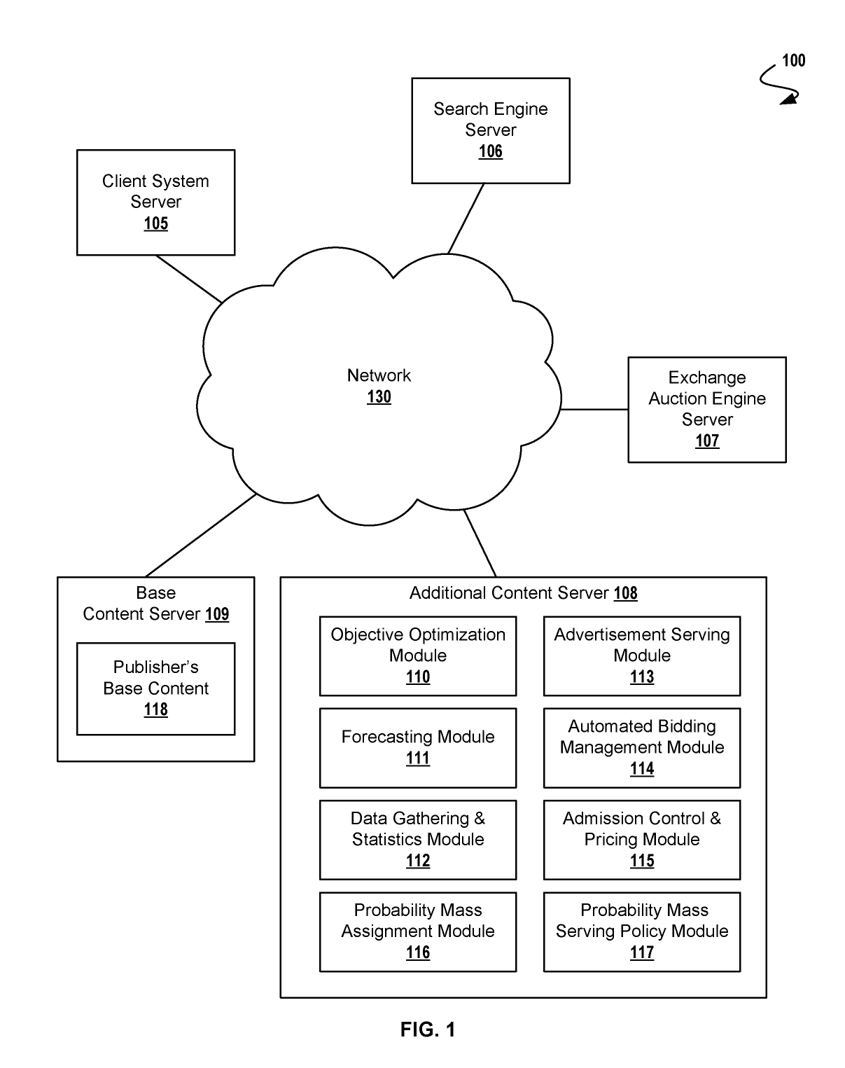

FIG. 1 depicts an advertising server network environment including modules for implementing a mass-based approach for serving impressions in guaranteed delivery advertising, in which some embodiments operate. Otherwise stated, the advertising server network environment implements a system for delivery of display advertising. In the context of internet advertising, placement of advertisements within an internet environment (e.g. environment 100 of FIG. 1) has become common. By way of a simplified description, an internet advertiser may select a particular property (e.g. Yahoo.com/Finance, or Yahoo.com/Search), and may create an advertisement such that whenever any internet user, via a client system 105 renders the web page from the selected property, possibly using a search engine server 106, the advertisement is composited on a web page by one or more servers (e.g. base content server 109, additional content server 108) for delivery to a client system 105 over a network 130. Given this generalized delivery model, and using techniques disclosed herein, sophisticated online advertising might be practiced. More particularly, an advertising campaign might include highly-customized advertisements delivered to a user corresponding to highly-specific target predicates. Again referring to FIG. 1, an internet property (e.g. a publisher hosting the publisher's base content 118 on a base content server 109) might be able to measure the number of visitors that have any arbitrary characteristic, demographic, target predicates, or attribute, possibly using an additional content server 108 in conjunction with a data gathering and statistics module 112. Thus, an internet user might be ‘known’ in quite some detail as pertains to a wide range of target predicates or other attributes.

Therefore, multiple competing advertisers might elect to bid in a market via an exchange auction engine server 107 in order to win the most prominent spot, or an advertiser might enter into a contract (e.g. with the internet property, or with an advertising agency, or with an advertising network, etc) to purchase the desired spots for some time duration (e.g. all top spots in all impressions of the web page empirestate.com/hotels for all of 2010). Such an arrangement, and variants as used herein, is termed a contract.

In embodiments of the systems within environment 100, components of the additional content server perform processing such that, given an advertisement opportunity (e.g. an impression opportunity profile predicate), processing determines which (if any) contract(s) match the advertisement opportunity. In some embodiments, the environment 100 might host a variety of modules to serve management and control operations (e.g. an objective optimization module 110, a forecasting module 111, a data gathering and statistics module 112, an advertisement serving module 113, an automated bidding management module 114, an admission control and pricing module 115, a probability mass assignment module 116, a probability mass serving policy module 117, etc) pertinent to serving advertisements to users, including serving ads under guaranteed delivery terms and conditions. In particular, the modules, network links, algorithms, assignment techniques, serving policies, and data structures embodied within the environment 100 might be specialized so as to perform a particular function or group of functions reliably while observing capacity and performance requirements. For example, an additional content server 108, possibly in conjunction with a probability mass serving policy module 117 might be employed to implement a mass-based approach for serving impressions in guaranteed delivery advertising.

### Booking and Serving Within a Guaranteed Delivery Setting

In a guaranteed delivery setting the publisher faces two major problems. The first is that of accurate booking—the publisher's goal is to sell all of its inventory to guaranteed contracts. The leftover inventory is typically sold on a non-guaranteed marketplace and fetches much lower prices. The second is that of accurate serving—given a set of booked contracts and a visit by a user, decide which of the eligible contracts to show to the user so that all of the contracts are satisfied.

A simple approach addressing these problems might be worded as follows: At the time of booking, solve an allocation problem using forecasted user visits and existing booked contracts to see if the addition of a new booked contract is still feasible; if so, admit the new contract, else reject it. Similarly, at the time of serving, solve the same allocation problem using current and predicted future user visits and booked contracts, and serve the ad corresponding to the contract allocated to the current user visit. In some cases, this approach may be impractical because it may not be practical to obtain and optimize for all future visits at the time of serving. Note that if the ad server serves using a different—say, greedy—serving policy instead of solving the allocation problem, then it will under-deliver because it may not be able to find the feasible solution as was found in the earier timeframe by the booking system.

Another approach might be to solve the allocation problem at the time of booking, and then send the solution to the ad server so that it can simply “follow” the solution. For instance, the solution produced by the booking system might look like:
Serve 1st Sports visit of User A on June 1 to Contract 1
Serve 2nd Sports visit of User A on June 1 to Contract 2
Serve 1st Finance visit of User B on June 1 to Contract 1

The ad server can then simply follow the solution and serve the ad corresponding to Contract 1 to the first visit of User A, and so on. However, this approach may not be feasible because (a) the solution is extremely large given tens of billions of impressions processed per day and, (b) while it is possible to predict the overall distribution of user visits, it is impossible to reliably predict which specific users are going to visit at a specific time.

### Problem Statement Pertaining to Guaranteed Delivery Display Advertising

Given the limitations of the aforeto discussed simple approaches, the question that arises becomes: Is there a way to leverage the time, resources, and approximate long-term forecast information available at booking time to produce a compact and generalizable plan for the ad server that can be used in real-time to serve ads for actual user visits? The key requirements here are compactness, which ensures that the information can be meaningfully stored in the ad server, generalizability, which ensures that decisions made on approximate forecast information translate to meaningful actions on real user visits, and real-time execution, which requirement demands that the ad server can make reliable decisions (and within a span of time on the order of hundreds of milliseconds).

### Booking and Serving Problem Formalization

Let I be the set of user visits and J be the set of contracts. Then denote a user visit using subscript i and denote a contract using subscript j. Each user visit i can be represented as a collection (e.g. set, vector) of attribute-value pairs (e.g. target predicates) that include the properties of the user, the properties of the web pages the user is visiting, and the time of the visit. For instance, a visit by a Male user from New York interested in travel and visiting a Sports page on 31 Jan. 2010 at 10 pm might have a target predicate represented as: Gender=Male, Location=New York, Category=Sports, Interests=Travel, Time=31 Jan. 2010 10 pm. Similarly, each contract j can represented as one or more Boolean expressions characterizing the user visit attributes (e.g. event predicates). For instance, a contract that targets Males visiting Sports pages in the month of January might have an event predicate represented as: Gender e {Male}̂Categoryε{Sports}̂Durationε[1 Jan. 2010, 31 Jan. 2010]. In addition, each contract j further specifies its demand, i.e. the number of user visits that are guaranteed to be shown, which is denoted by dⱼ. A plurality of contracts might be represented in an inverted index such that one or more contracts might be retrieved via the index using one or more target predicates.

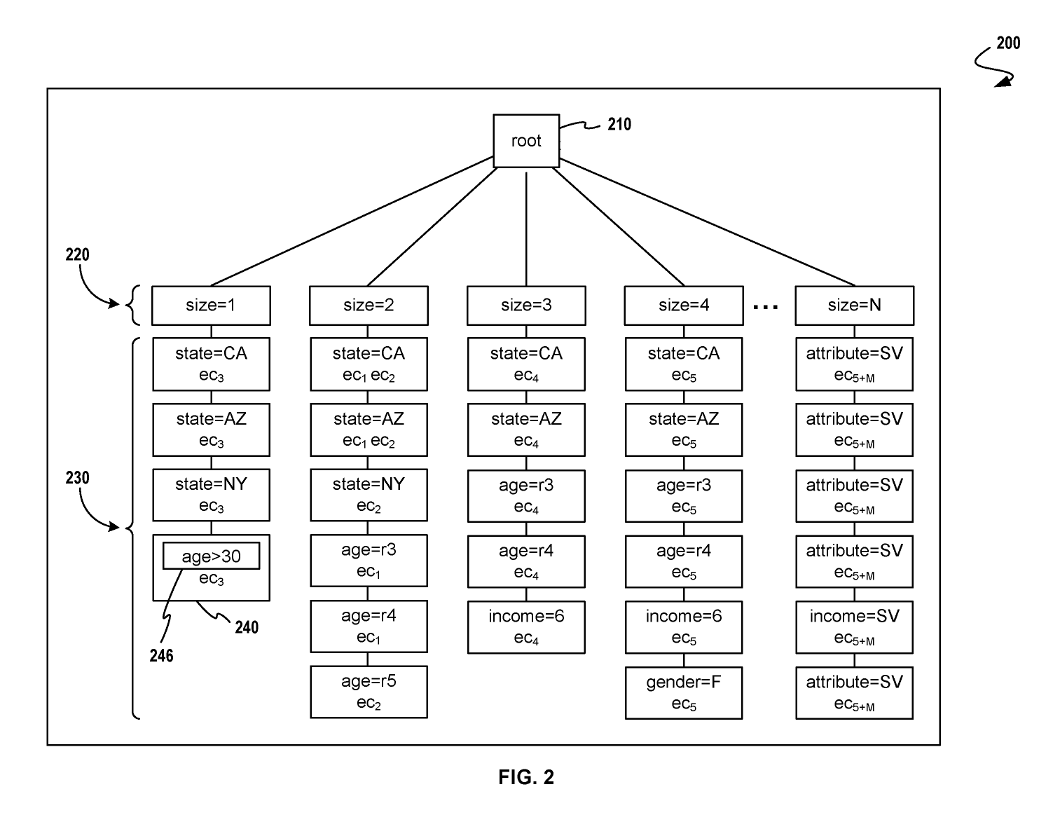

FIG. 2 shows an index with target predicates 200 in the form of an inverted index. As an option, the inverted index may be implemented in the context of the architecture and functionality of the embodiments described herein. Of course, however, the index with target predicates 200 or any portion therefrom may be used in any desired environment. As shown, an index with target predicates 200 in the form of an inverted index comprises a tree structure stemming from an inverted index root 210 into the inverted index branches 220 (labeled as size=1, size=3, size=N) under which inverted index branches 220 are index predicate nodes 230. In the particular embodiment shown, the index predicate nodes 230 are labeled with a predicate (e.g. state=CA, state=AZ, etc), and with corresponding labels indicating one or more particular contracts (e.g. ec₁, ec₂, ec₃, etc) that might be satisfied with respect to the predicate of that node. For example, for the sample node 240, contract ec₃ might be eligible (at least in part) when the example target predicate 246 age>30 is true. Of course, the foregoing structure is only an illustrative example, and other structures are reasonable and envisioned.

In more formal terms, one might say that a user visit iεI is eligible for contract jεJ if (and only if) it satisfies the target predicates of j; it can also sometimes be said that j is eligible for i in this case. Thus, a bipartite eligibility graph can be constructed.

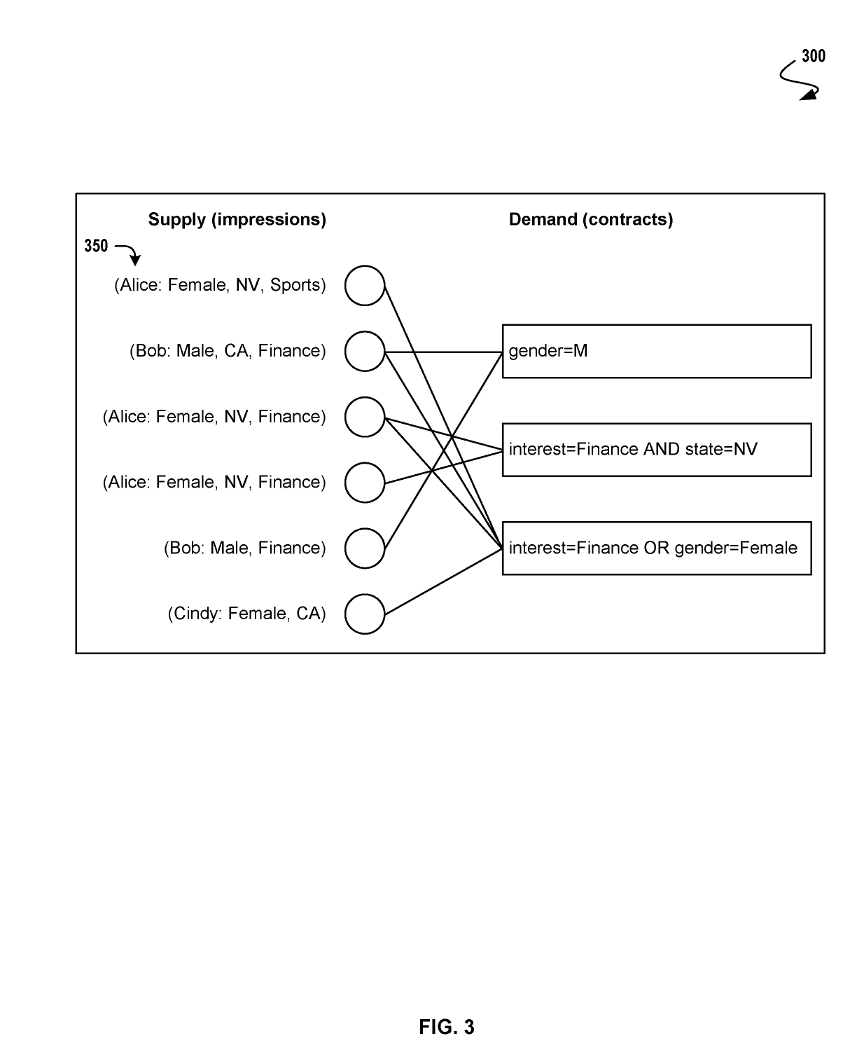

FIG. 3 depicts an allocation of impressions to contracts in the form of a bipartite eligibility graph 300.

The left-hand vertices (depicted as circles) consist of I (i.e. a supply of impressions); the right-hand vertices (depicted as rectangles) consist of J (i.e. demand from contracts). The edge-set, E, consists of edges (i, j) such that i is eligible for contract j. The set of user visits eligible for contract j is denoted by E(j). Likewise, the set of contracts eligible for i is denoted by E(i). Note that the eligibility graph shows the target predicates set annotated beside the contracts.

### Allocation Problem

In an exemplary allocation problem, a publisher may be associated with a set of booked contracts, and the publisher may posess information about future user visits, which forecast might be obtained from a forecasting module 111. One possible allocation problem goal can be described as: Find an allocation of user visits to contracts such that every user visit is allocated to at most one contract, and each contract j is allocated to at least d₁ impressions. Let xε{0,1}^{E} denote the allocation; set xᵢⱼ=1 to mean that the ad associated with contract j is shown for the impression i, and xᵢⱼ=0 otherwise.

The publisher may have some objective function, H:{0,1}^{E}→R, over the set of feasible allocations. Such an objective function generally relates the goals of revenue, advertiser satisfaction, and user happiness, though other objective functions are reasonable and envisioned.

Thus, the allocation problem may be formally written as:

$$\begin{matrix}Maximize H ( x ) & & \\ & s . t . ∀ j , {\sum }_{i ∈ E ( j )} {x}_{ij} \geq {d}_{j} & subject to a demand constraint \\ & ∀ i , {\sum }_{j ∈ E ( i )} {x}_{ij} \leq 1 & subject to a supply constraint \\ & ∀ i , j , {x}_{ij} ∈ \{ 0 , 1 \} & subuject to an integrality constraint\end{matrix}$$

However, the allocation problem itself presents many difficulties. A bipartite eligibility graph 300 corresponding to commercially reasonable characteristics might include billions of user visits (e.g. impression opportunities 350), and tens of thousands of contracts, resulting in trillions of edges in the bipartite eligibility graph 300.

One way to make the problem more tractable is to reduce the size of the overall problem by sampling from the set of user visits. For example, a sampling might be comprised from a uniform sample of, for example, 10% of user visits, and scale each of the demands appropriately (in this example dividing them by a factor of 10). Although a sampling may not be a perfect representation of the whole set sampled, the resulting problem is smaller by an order of magnitude and, thus, might be easier to solve (especially for a small bipartite eligibility graph). However, even after sampling, the bipartite eligibility graph might still include many hundreds of thousands of edges, and the solution might become long, and might involve significant computing cycles.

A second complementary way of reducing the solution-time problem is to relax the integrality constraint, replacing it with the more flexible constraint, 0≦xᵢⱼ>1 thus expressing xᵢⱼ as a probability of allocating i to j. Then in the allocation problem, the demand constraint holds in expectation.

A Chernoff bound may be used in this randomized algorithm to determine a bound on the number of runs necessary to determine a value by majority agreement—up to a specified probability. Since the typical demand is on the order of hundreds of thousands of impressions, an application of Chernoff bounds proves that any integral realization of the fractional solution will violate the demand by at most 1% with high probability. Using the above two techniques, the reduced allocation problem is usually solvable in practice (e.g. using one or more modules within an additional content server 108).

### Booking Problem

In the booking problem, the publisher has a set of already booked contracts and certain statistical predictions as well as other information about future user visits. In this booking problem, an advertiser wishes to book a new contract j′ targeting a specific subset of users, iεE(j′). The goal of the publisher is to find the maximum amount of inventory that they can allocate to the new contract. That is, the publisher needs to solve the following variant of the allocation problem:

$$\begin{matrix}Maximize {\sum }_{i ∈ E ( j )} {x}_{{ij}^{′}} & & \\ & s . t . ∀ j , {\sum }_{i ∈ E ( j )} {x}_{ij} \geq {d}_{j} & subject to a demand constraint \\ & ∀ i , {\sum }_{j ∈ E ( i )} {x}_{ij} + {x}_{{ij}^{′}} \leq 1 & subject to a supply constraint \\ & ∀ i , j , 0 \leq {x}_{ij} \leq 1 & subuject to a relaxed constraint\end{matrix}$$

The above booking problem may be expressed as a bi-partite graph network flow, and thus solved quickly using modern computing techniques.

### Serving Problem

In the serving problem, the publisher wishes to implement a series of decisions that inplement a feasible solution to the allocation problem. That is, as each user visit occurs, the publisher (or agent for the publisher) must make an immediate and irrevocable decision as to which contract to serve. The goal is to make the series of serving decisions such that, at least approximately, the planned allocation is achieved. Of course, the challenge here lies in the dearth of information and lack of resources available at serving time.

For example, a serving policy that precomputes an allocation for each user visit may underperform as it may be impossible to forecast exactly how many times a user will appear. Furthermore, a desired allocation plan should be general enough to be able to handle new users that have never been part of the system before (and thus not considered in earlier forecasting).

TABLE 1
Possible serving policies

| Policy Statement | Effect in Expectation |
|---|---|
| Pre-compute an allocation and | Actual impressions arriving in |
| implement that allocation | future may differ from the |
| | allocation plan |
| Pre-compute an allocation and | Stateful allocation may require |
| implement that allocation | vast computing resources |
| Serve to oldest contract | May over-serve the oldest |
| | contracts while under-serving |
| | newer contracts |
| Serve to contract soonest to | May under-serve contracts until |
| expire | it is too late to catch up |

One possible solution to the serving problem is to run an offline optimization to produce an allocation plan, which can then be interpreted by an advertisement serving module 113.

One way to generate an allocation plan is to observe an objective function for meeting guarantees of the guaranteed delivery contracts. In some embodiments, the essence of an allocation plan resides in a single number for each contract, called its mass.

### Serving Problem Solution Using a Mass-based Approach for Serving Impressions in Guaranteed Delivery Advertising

When the ad server processes a user visit, it first finds the set of contracts eligible for the user visit. It then probabilistically allocates the user visit to one of the eligible contracts, where the probability of allocating the user visit to a contract is proportional to the mass of the contract. That is, if the user visit is eligible for k contracts with masses m₁ . . . mₖ, then the user visit is allocated to contract j with probability mⱼ/Σᵢmᵢ,

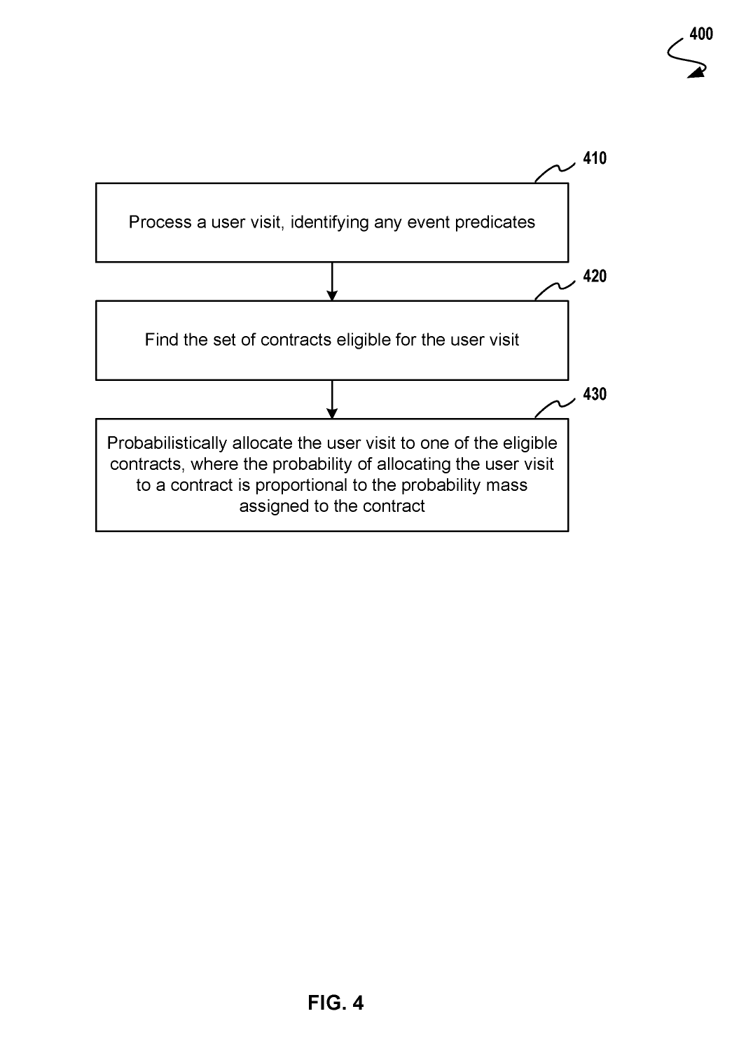

FIG. 4 is a flowchart of a method 400 for implementing a mass-based approach for serving impressions in guaranteed delivery advertising. As shown, the method commences when the ad server processes a user visit (see operation 410), and proceeds to find the set of contracts eligible for allocation to a user visit with demographics the same or similar to the specific user visit (see operation 420). The operations of processing a user visit may include determining the event predicates corresponding to the visiting user. For example, a user might posess a cookie or other record indicating the demographics of the user. Following the example of FIG. 3, a visit by Cindy might be processed for determining the event predicates corresponding to “gender=Female, state=CA”.

The method 400 then probabilistically allocates the user visit to one of the eligible contracts, where the probability of allocating the user visit to a contract is proportional to the mass of the contract (see operation 430).

In further detail, and following earlier disclosure, every contract is assigned a mass. A mass may be represented as a single positive number. At serving time, when a user visit arrives, first find the event predicates (see operation 410) and then find the set of eligible contracts (see operation 420). Then allocate the user visit to one of these contracts at random, with probability proportional to the contract's mass. That is, if the user visit eligible to be served to k contracts with masses m₁ . . . mₖ, then the user visit is allocated to contract j with probability mⱼ/Σᵢmᵢ. In some cases there might exist more supply than can be consumed by the set of eligible guaranteed contracts. In such a case, an artificial contract (a ‘ghost contract’) can be added to the set of eligible contracts, the ghost contract serving as a proxy for a set of non-guaranteed contracts. Thus, when the ad server allocates a visit to this ghost contract, it in effect allocates the user visit to a non-guaranteed contract.

### Simulating A Serving Problem Solution Using a Mass-based Approach for Serving Impressions in Guaranteed Delivery Advertising

Now described is an iterative algorithm to calculate the masses that are then assigned to contracts. Initially, construct the left side of a graph similar to the form of the bipartite eligibility graph 300, and construct the right side of a graph similar to the form of the bipartite eligibility graph 300. For each contract on the right side of the graph, initialize the mass of each contract to equal 1. Simulate what the delivery to each contract would be (in expectation) if each user visit appearing in the linked eligibility graph is served, based on the then current masses. In particular, for any setting of the masses, \hat{m}, define delivery ⱼ(\hat{m}) to be the expected delivery to contract j. That is,

$${delivery}_{j} ( {m}^{->} ) = {\sum }_{i ∈ {E}_{L} ( j )} {m}_{j} / {M}_{i} ,$$

where for each i, Mᵢ=Σ_{j′εE}_{_{L}}₍ᵢ₎m_{j′}. Notice that for any γ>0, that delivery ⱼ(γ\vec{m})=delivery ⱼ(\vec{m}).

For each contract j, increase its mass in proportion to its demand divided by its expected delivery, delivery ⱼ. If a contract j is underdelivering, then iterate the simulation and update until all demands are satisfied. In some embodiments, the demand may be padded by a padding value ε to ensure better convergence. The pseudo-code is given in Algorithm 1 below.

By virtue of its stopping condition, Algorithm 1 (below) is guaranteed to produce an allocation plan that ensures every contract meets its demand (in expectation), so long as the algorithm actually stops. In fact, it can be shown that it is guaranteed to converge, so long as the demands of all contracts (padded by (1+2ε)) are feasible. In practice, the demand of contracts can be trimmed somewhat to ensure feasibility.

Algorithm 1: Assigning a mass to a contract
by simulating a series of supply events

Input: The linked eligibility graph, and padding value ε>0
Result: The masses, mⱼ, for all contracts j are set appropriately
Initialize mⱼ=1 and deliveryⱼ=0 for all contracts j;
while deliveryⱼ<dⱼ for some j do

// Compute the expected delivery for each contract;
Set deliveryⱼ=deliveryⱼ(\vec{m}).;
// Update the masses;
foreach contract j do

mⱼ=mⱼ×max(1,(1+ε)dⱼ/deliveryⱼ);

end

end

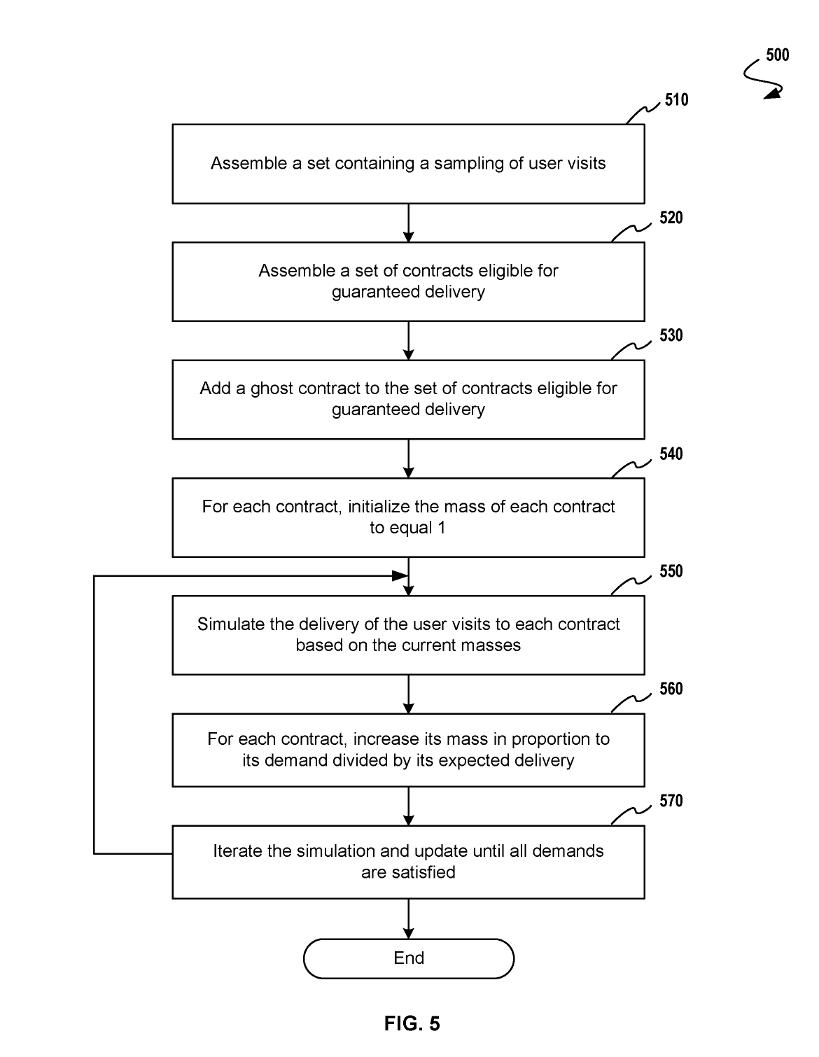

FIG. 5 is a flowchart of a method for assigning a mass to a contract by simulating a series of supply events. Of course, the method 500 for assigning a mass to a contract by simulating a series of supply events is an exemplary embodiment, and some or all (or none) of the functionalities mentioned in the discussion of method 500 might be carried out in any environment. As shown the method 500 commences by assembling a set containing a sampling of user visits (see operation 510). For example, the supply events (e.g. impression opportunities 350), and possibly many more such supply events might be selected when assembling a set containing a sampling of user visits. In the embodiment shown, the method 500 proceeds to assemble a set of contracts that are eligible for guaranteed delivery (see operation 520), possibly using an index with target predicates 200. In the situation that the supply is expected to be greater than the aggregate demand, then a ghost contract (for representing a set of non-guaranteed booked contracts) might be added to the set of contracts (see operation 530). Initially, the probability mass of each contract in the set is set to the value “1” (see operation 540).

Then a series of iterations commences (see operation 550 through operation 570) for simulating a series of supply events, and iteratively calculating a probability mass for each of the booked contracts, wherein said calculating includes a simulation of a series of supply events. More specifically, the iterations may include simulating the delivery of the user visits to each contract based on the current probability masses, which probability masses generally vary over the iterations (see operation 550). Then, based on the demand divided by expected delivery (as described supra), increase the probability mass (see operation 560). The method as shown continues the iterations until all demands are satisfied (see operation 570).

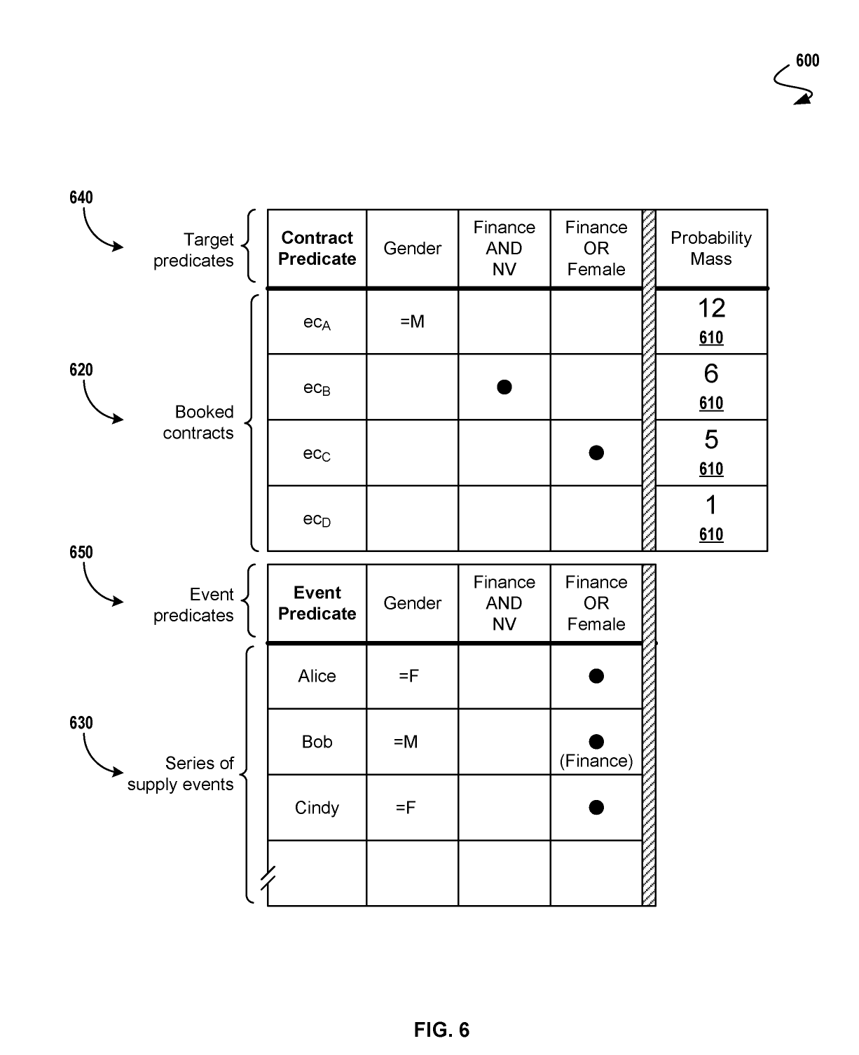

FIG. 6 is a depiction of a data structure for assigning a mass to a contract after simulating a series of supply events. Of course, the system 600 for assigning a mass to a contract after simulating a series of supply events 630 is an exemplary embodiment, and some or all (or none) of the functionalities mentioned in the discussion of system 600 might be carried out in any environment. As shown, booked contracts 620 are arranged into rows in a data structure, each contract having a corresponding probability mass 610. The contracts have one or more target predicates 640, and the events have one or more event predicates 650. A contract's target predicate(s) may be used for retrieving, from an index, a set of eligible contracts, wherein an eligible contract comprises at least one target predicate matching at least a portion of the event predicate. As shown, the event predicate for the user visit labeled as “Bob” (which user Bob is associated with gender=M) could be served to eligible contract ec_{A} by virtue of the fact that Bob is male, or it could be served to eligible contract ec_{C} by virtue of the fact that Bob is interested in finance. Now, having the two eligible contracts ec_{A} (with probability mass 12) and ec_{C} (with probability mass 5), contract ec_{A} will be served probabilistically 12 out of 17 times, and contract ec_{C} will be served probabilistically 5 out of 17 times. Of course there are many techniques for modeling probabilities and for using random numbers in conjunction with the modeled probabilities. One such technique involves assigning the probability masses to non-overlapping intervals within a contiguous range. Such a technique may be conveniently implemented within a computer memory (e.g. main memory 1210).

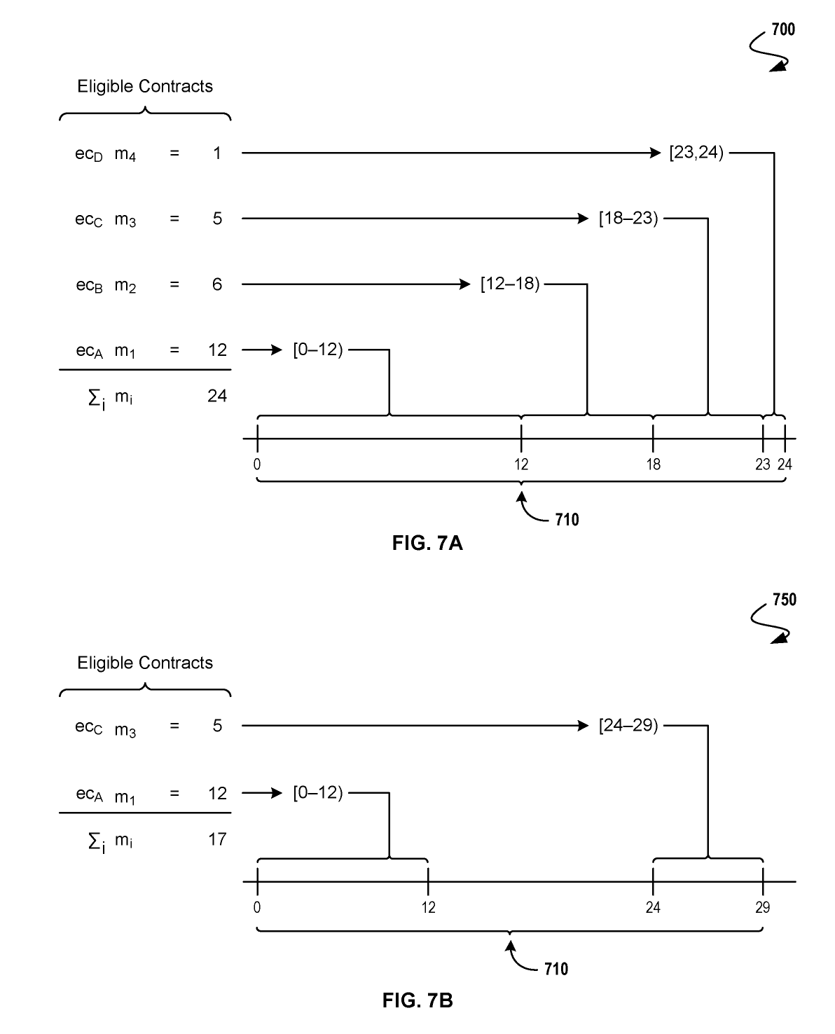

FIG. 7A is a depiction of a technique for assigning eligible contracts to non-overlapping intervals within a contiguous range. Of course, the system 700 for assigning eligible contracts to non-overlapping intervals within a contiguous range is an exemplary embodiment, and some or all (or none) of the functionalities mentioned in the discussion of system 700 might be carried out in any environment. As shown, the probability masses of the group of eligible contracts (i.e. ec_{A}, ec_{B}, ec_{C}, ec_{D}) are mapped to a contiguous range. In this case, the contiguous range (e.g. sized range 710) ranges from zero to the sum of the masses of the eligible contracts, as calculated by Σᵢmᵢ.

FIG. 7B is a depiction of a technique for assigning eligible contracts to non-overlapping intervals within a non-contiguous range. Of course, the system 750 for assigning eligible contracts to non-overlapping intervals within a non-contiguous range is an exemplary embodiment, and some or all (or none) of the functionalities mentioned in the discussion of system 750 might be carried out in any environment. In the case as shown, and following the example of FIG. 6, the probability masses of the group of eligible contracts (i.e. ec_{A}, ec_{C}) are mapped to a non-contiguous range. More specifically, the operations depicted in the mapping of system 750 can be said to be assigning, in a one-to-one correspondence, each eligible contract from among the set of eligible contracts to an interval within a sized range (e.g. sized range 710). Observe that, in the case that eligible contracts (i.e. ec_{A}, ec_{C}) are assigned to a non-contiguous range (e.g. following the example of system 750), then in the subsequent operation(s) for generating a pseudo-random number, a series of pseudo-random numbers might be generated, and the operation discards those pseudo-random numbers that do not fall within any assigned interval.

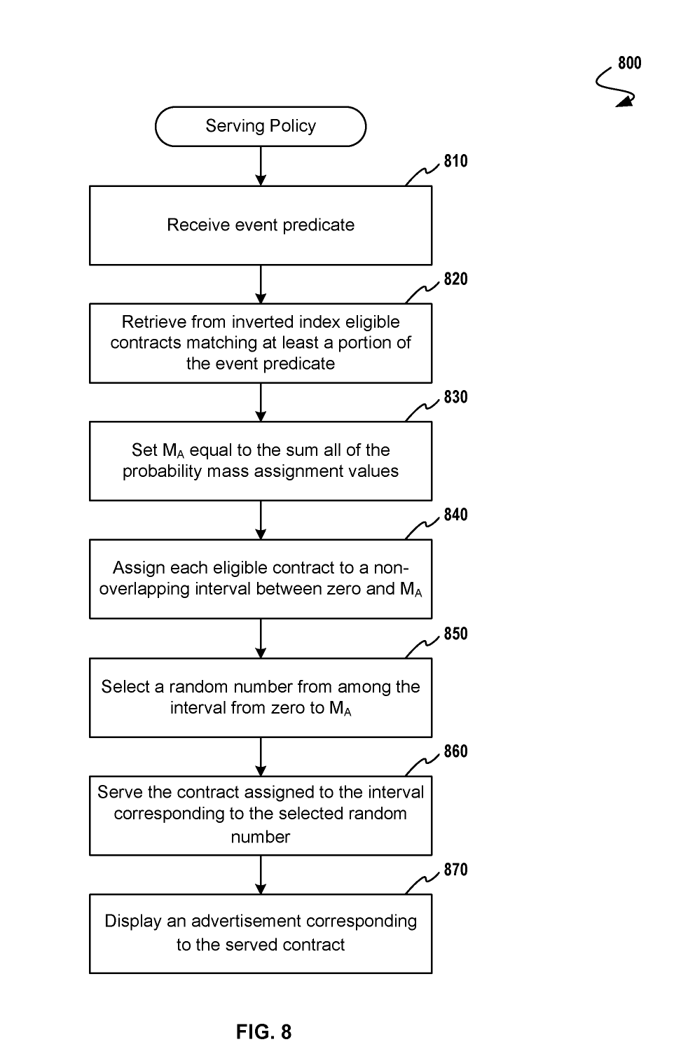

FIG. 8 is a flowchart of a method for implementing operations within a mass-based approach for serving impressions in guaranteed delivery advertising. Of course, the method 800 for implementing operations within a mass-based approach for serving impressions in guaranteed delivery advertising is an exemplary embodiment, and some or all (or none) of the operations mentioned in the discussion of method 800 might be carried out in any environment. As shown, a serving policy might be implemented using some of all of the operations of method 800. In particular, an event predicate might be received by a server such as an additional content server 108 (see operation 810) and, based on the event predicate, a server might retrieve from an index a set of eligible contracts. In some embodiments, an eligible contract is a contract for which at least some portion of the contract's target predicates match the aforementioned event predicate (see operation 820). Once the index has returned the set of eligible contracts, the values of the masses associated with each of the set of eligible contracts is summed (see operation 830). In the embodiment described, and having then the definition of a range (e.g. from zero to the aforementioned sum) each of the masses might be arranged in a contiguous and non-overlapping manner across the range (see operation 840). A parameterized random number generator might then be used to select a number from within the range (see operation 850). The generated random number may then be used to select one of the intervals, and the contract associated with that interval is then selected to be served (see operation 860). Once a contract has been selected, then system 800 may communicate with other modules within environment 100 for displaying (to the visitor precipitating the event predicate mentioned in operation 810) an advertisement corresponding to the served contract (see operation 870). As shown and described, this policy will serve the eligible contracts relatively evenly, and will meet the demands of the contracts within the limits, and with the likelihood, of the Chernoff bounds, as earlier described.

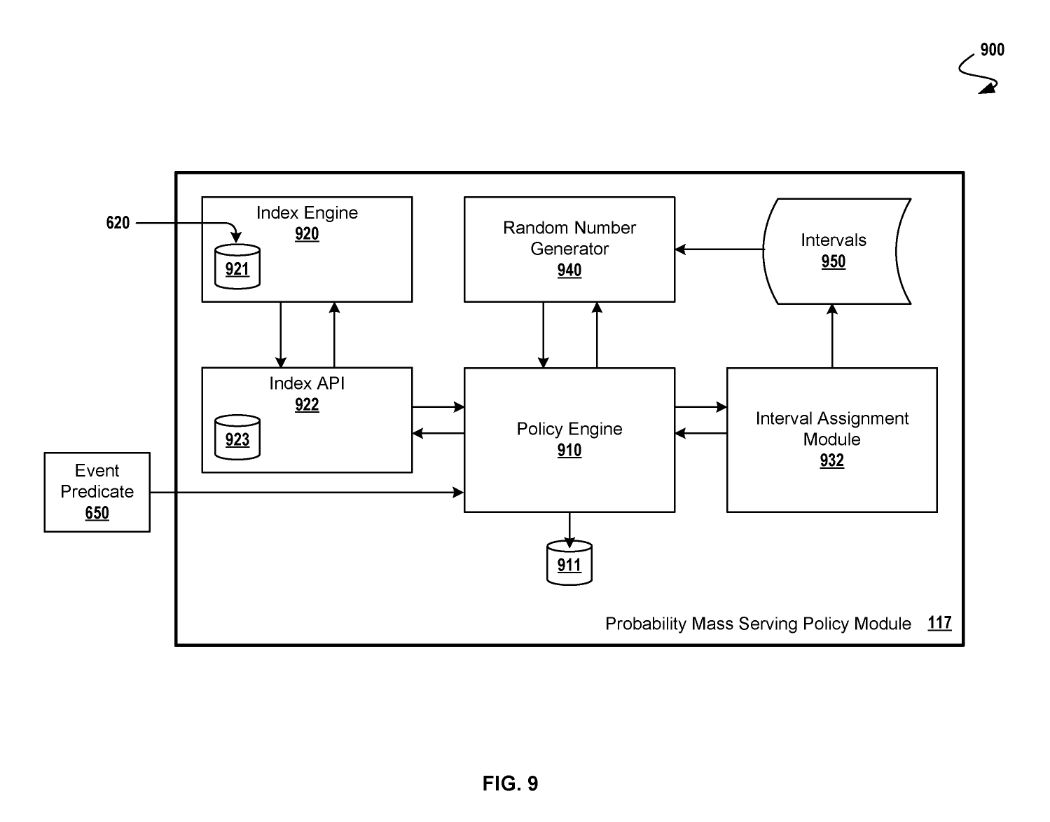

FIG. 9 is a system diagram of a system implementing operations within a mass-based approach for serving impressions in guaranteed delivery advertising. Of course, the method 900 for implementing operations within a mass-based approach for serving impressions in guaranteed delivery advertising is an exemplary embodiment, and some or all (or none) of the operations mentioned in the discussion of method 900 might be carried out in any environment. As shown, a probability mass serving policy module 117 includes a policy engine 910 which in turn is in communication with a index engine 920 through an index API 922. In operation, the probability mass serving policy module 117 is operable for serving impression opportunities to a booked contract 620 by receiving, from a server, an event predicate 650 and retrieving, from an index 921, possibly using an index engine 920 and an index API 922, a set of eligible contracts 923, wherein an eligible contract comprises at least one target predicate matching at least a portion of the event predicate 650. An interval assignment module 932 serves for assigning, in a one-to-one correspondence, each eligible contract from among the set of the eligible contracts 923 to a plurality of intervals 950 within a sized range. The intervals 950 may be described within a computer memory in any abstract representation, possibly including a representation of a number line or merely a range of numbers. A random number generator 940 serves for generating a pseudo-random number. In exemplary embodiments, the random number generator 940 might be parameterized so as to return a pseudo-random number within a specified range.rther, in exemplary embodiments, the selected pseudo-random numbers fall within exactly one interval of said plurality of intervals. Thus, having exactly one interval identified from said plurality of intervals, that interval may be used for selecting a served contract 911, said served contract corresponding to the exactly one interval.

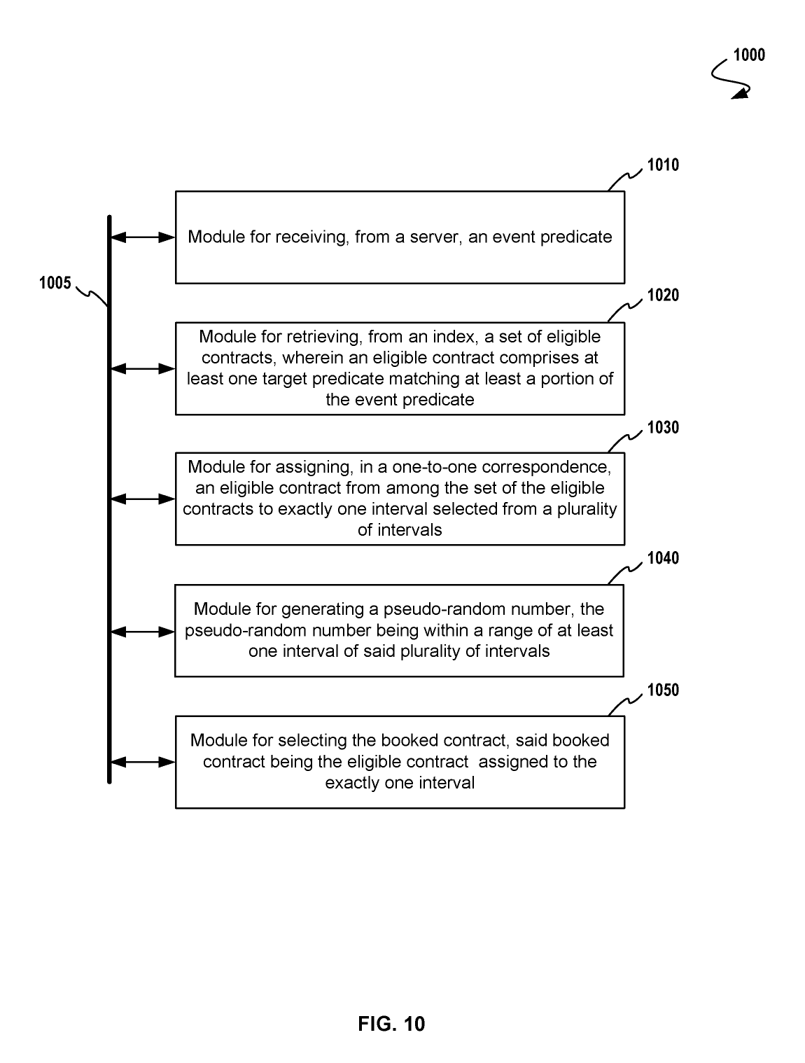

FIG. 10 depicts a block diagram of a system for delivery of display advertising. As an option, the present system 1000 may be implemented in the context of the architecture and functionality of the embodiments described herein. Of course, however, the system 1000 or any operation therein may be carried out in any desired environment. As shown, system 1000 includes a plurality of modules, each connected to a communication link 1005, and any module can communicate with other modules over communication link 1005. The modules of the system can, individually or in combination, perform method steps within system 1000. Any method steps performed within system 1000 may be performed in any order unless as may be specified in the claims. As shown, system 1000 implements a method for delivery of display advertising, the system 1000 comprising modules for: receiving, from a server, an event predicate (see module 1010); retrieving, from an index, a set of eligible contracts, wherein an eligible contract comprises at least one target predicate matching at least a portion of the event predicate (see module 1020); assigning, in a one-to-one correspondence, an eligible contract from among the set of the eligible contracts to exactly one interval selected from a plurality of intervals (see module 1030); generating a pseudo-random number, the pseudo-random number being within a range of at least one interval of the plurality of intervals (see module 1040); and selecting the booked contract, the booked contract being the eligible contract assigned to the exactly one interval (see module 1050).

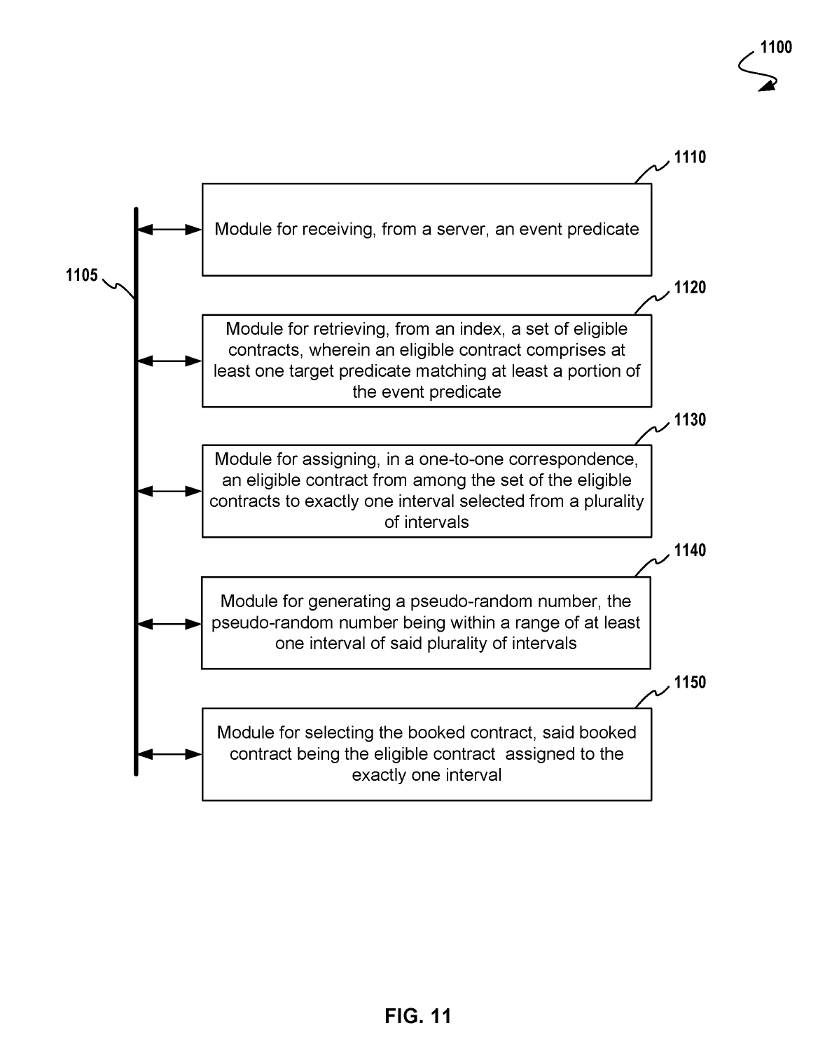

FIG. 11 depicts a block diagram of a system to perform certain functions of an advertising server network. As an option, the present system 1100 may be implemented in the context of the architecture and functionality of the embodiments described herein. Of course, however, the system 1100 or any operation therein may be carried out in any desired environment. As shown, system 1100 comprises a plurality of modules including a processor and a memory, each module connected to a communication link 1105, and any module can communicate with other modules over communication link 1105. The modules of the system can, individually or in combination, perform method steps within system 1100. Any method steps performed within system 1100 may be performed in any order unless as may be specified in the claims. As shown, FIG. 11 implements an advertising server network as a system 1100, comprising modules including a module for receiving, from a server, an event predicate (see module 1110); a module for retrieving, from an index, a set of eligible contracts, wherein an eligible contract comprises at least one target predicate matching at least a portion of the event predicate (see module 1120); a module for assigning, in a one-to-one correspondence, an eligible contract from among the set of the eligible contracts to exactly one interval selected from a plurality of intervals (see module 1130); a module for generating a pseudo-random number, the pseudo-random number being within a range of at least one interval of the plurality of intervals (see module 1140); and a module for selecting the booked contract, the booked contract being the eligible contract assigned to the exactly one interval (see module 1150).

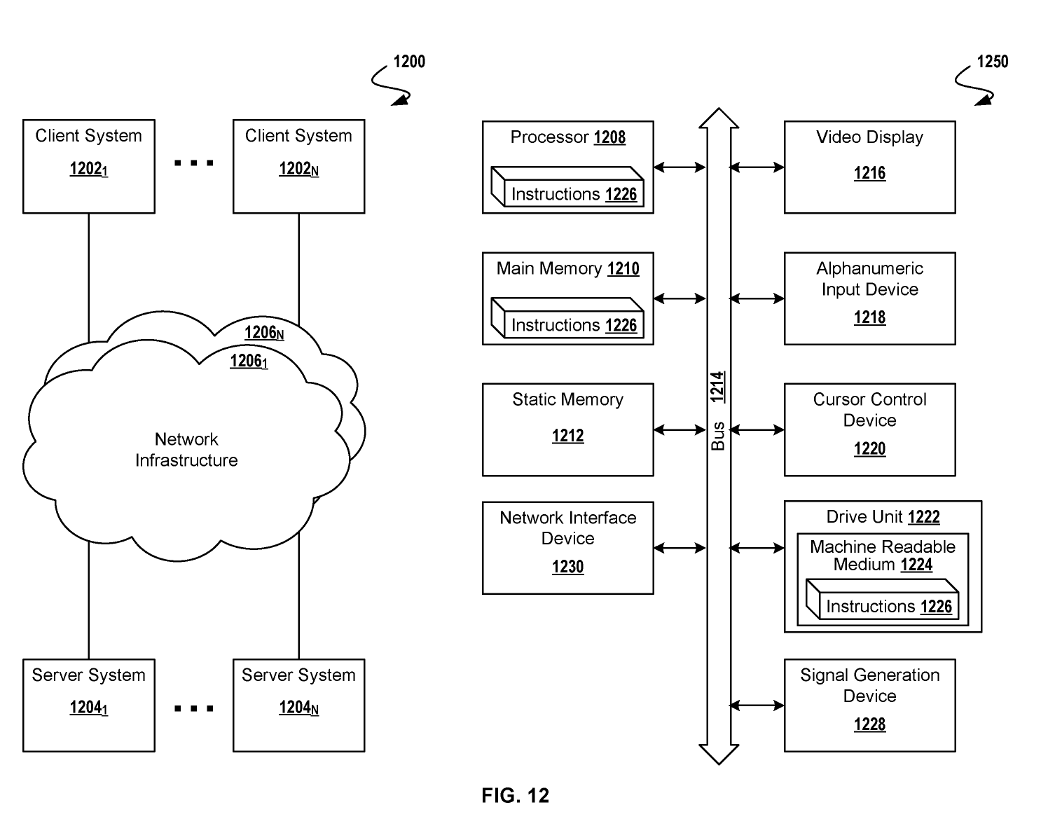

FIG. 12 is a diagrammatic representation of a network 1200, including nodes for client computer systems 1202₁ through 1202_{N}, nodes for server computer systems 1204₁ through 1204_{N}, nodes for network infrastructure 1206₁ through 1206_{N}, any of which nodes may comprise a machine 1250 within which a set of instructions for causing the machine to perform any one of the techniques discussed above may be executed. The embodiment shown is purely exemplary, and might be implemented in the context of one or more of the figures herein.

Any node of the network 1200 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1250 includes a processor 1208 (e.g. a processor core, a microprocessor, a computing device, etc), a main memory 1210 and a static memory 1212, which communicate with each other via a bus 1214. The machine 1250 may further include a display unit 1216 that may comprise a touch-screen, or a liquid crystal display (LCD), or a light emitting diode (LED) display, or a cathode ray tube (CRT). As shown, the computer system 1250 also includes a human input/output (I/O) device 1218 (e.g. a keyboard, an alphanumeric keypad, etc), a pointing device 1220 (e.g. a mouse, a touch screen, etc), a drive unit 1222 (e.g. a disk drive unit, a CD/DVD drive, a tangible computer readable removable media drive, an SSD storage device, etc), a signal generation device 1228 (e.g. a speaker, an audio output, etc), and a network interface device 1230 (e.g. an Ethernet interface, a wired network interface, a wireless network interface, a propagated signal interface, etc).

The drive unit 1222 includes a machine-readable medium 1224 on which is stored a set of instructions (i.e. software, firmware, middleware, etc) 1226 embodying any one, or all, of the methodologies described above. The set of instructions 1226 is also shown to reside, completely or at least partially, within the main memory 1210 and/or within the processor 1208. The set of instructions 1226 may further be transmitted or received via the network interface device 1230 over the network bus 1214.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for serving impression opportunities to a booked contract in a system for delivery of display advertising, comprising:
receiving, from a server, an event predicate;
retrieving, from an index, a set of eligible contracts, wherein an eligible contract comprises at least one target predicate matching at least a portion of the event predicate;
assigning, in a one-to-one correspondence, an eligible contract from among the set of the eligible contracts to exactly one interval selected from a plurality of intervals;
generating a pseudo-random number, the pseudo-random number being within a range of at least one interval of said plurality of intervals; and
selecting the booked contract, said booked contract being the eligible contract assigned to the exactly one interval.

2. The method of claim 1, further comprising calculating a probability mass for the booked contract, said calculating including a simulation of a series of supply events.

3. The method of claim 1, wherein the assigning the eligible contract from among the set of the eligible contracts to a plurality of intervals within a sized range uses a probability mass of the eligible contract.

4. The method of claim 1, further comprising displaying an advertisement corresponding to the selected booked contract.

5. The method of claim 1, wherein the assignment of the intervals results in an assignment to contiguous series of intervals.

6. The method of claim 1, wherein the assignment of the intervals results in an assignment to non-contiguous series of intervals.

7. The method of claim 1, wherein the generated pseudo-random number is constrained to be within the sized range.

8. A advertising server network for serving impression opportunities to a booked contract in a system for delivery of display advertising, comprising:
a module for receiving, from a server, an event predicate;
a module for retrieving, from an index, a set of eligible contracts, wherein an eligible contract comprises at least one target predicate matching at least a portion of the event predicate;
a module for assigning, in a one-to-one correspondence, an eligible contract from among the set of the eligible contracts to exactly one interval selected from a plurality of intervals;
a module for generating a pseudo-random number, the pseudo-random number being within a range of at least one interval of said plurality of intervals; and
a module for selecting the booked contract, said booked contract being the eligible contract assigned to the exactly one interval.

9. The advertising server network of claim 8, further comprising a module for calculating a probability mass for the booked contract, said calculating including a simulation of a series of supply events.

10. The advertising server network of claim 8, wherein the assigning the eligible contract from among the set of the eligible contracts to a plurality of intervals within a sized range uses a probability mass of the eligible contract.

11. The advertising server network of claim 8, further comprising displaying an advertisement corresponding to the selected booked contract.

12. The advertising server network of claim 8, wherein the assignment of the intervals results in an assignment to contiguous series of intervals.

13. The advertising server network of claim 8, wherein the assignment of the intervals results in an assignment to non-contiguous series of intervals.

14. The advertising server network of claim 8, wherein the generated pseudo-random number is constrained to be within the sized range.

15. A computer readable medium comprising a set of instructions which, when executed by a computer, cause the computer to serve impression opportunities to a booked contract in a system for delivery of display advertising, the set of instructions for:
receiving, from a server, an event predicate;
retrieving, from an index, a set of eligible contracts, wherein an eligible contract comprises at least one target predicate matching at least a portion of the event predicate;
assigning, in a one-to-one correspondence, an eligible contract from among the set of the eligible contracts to exactly one interval selected from a plurality of intervals;
generating a pseudo-random number, the pseudo-random number being within a range of at least one interval of said plurality of intervals; and
selecting the booked contract, said booked contract being the eligible contract assigned to the exactly one interval.

16. The computer readable medium of claim 15, further comprising instructions for calculating a probability mass for the booked contract, said calculating including a simulation of a series of supply events.

17. The computer readable medium of claim 15, wherein the assigning the eligible contract from among the set of the eligible contracts to a plurality of intervals within a sized range uses a probability mass of the eligible contract.

18. The computer readable medium of claim 15, further comprising displaying an advertisement corresponding to the selected booked contract.

19. The computer readable medium of claim 15, wherein the assignment of the intervals results in an assignment to contiguous series of intervals.

20. The computer readable medium of claim 15, wherein the assignment of the intervals results in an assignment to non-contiguous series of intervals.
